(19) United States
(12) Patent Application Publication
(10) Pub. No.: US 2003/0157824 A1
(43) Pub. Date: Aug. 21, 2003

(54) Power cord connecting set

(76) Inventor: Yoshinobu Ito, Tokyo (JP)

Correspondence Address: Mark M Friedman, Bill Polkinghorn, Discovery Dispatch, 9003 Florin Way, Upper Marlboro, MD, 20772, US

(21) Appl. No.: 10/204,628

(22) PCT Filed: Feb. 22, 2001
(86) PCT No.: PCT/JP01/01318

(30) Foreign Application Priority Data
Feb. 22, 2000 (JP) 2000-1-5566
Apr. 3, 2000 (JP) 2000-136391
Jan. 29, 2001 (JP) 2001-000345
Feb. 7, 2001 (JP) 2001-000509

(51) Int. Cl. H01R 13/627

(52) U.S. Cl. 439/350

(57) ABSTRACT

A power-cord connection set including a plug and an outlet, wherein an annular joining protrusion having a tapered cross-section is provided around the terminals of the plug and an annular joining depression having a tapered cross-section and corresponding to the annular joining protrusion is provided around the terminal receptors of the outlet.

### BACKGROUND OF THE INVENTION

1. Field of the Invention

The present invention relates to a power-cord connection set primarily for an electric or electronic apparatus.

2. Description of the Related Art

A general power-cord connection set well-known in the art includes a plug provided with a pair of plug terminals mounted in a plug case and an outlet provided with a pair of terminal receptors mounted in an outlet Case. Various plugs, such as those described in published unexamined patent applications Nos. HEI-8-255651 and 2000-182732, and outlets, such as those described in published unexamined patent application No. 2000-340286, have been proposed. These plugs and outlets are provided with connectors for forming a junction and connecting the lead wires provided in the plug power cord.

These connection sets are designed primarily for connecting lead wires of electric or electronic equipment. However, neither the power connection (and when necessary the ground connection) nor the connection of the plug and outlet units themselves is sufficiently reliable. If the plug and outlet are left connected for a long period of time, dust might collect at the connection and generate sparks. Further, water entering the connection area might cause a short circuit that can cause a fire.

Because the voltage used in power-cord connection sets having a ground wire is particularly high, the ground wire is designed to eliminate static electricity in the plug case and outlet Case that is generated by current flowing through those cases. However, if dust from the surrounding air is electrostatically attracted to the surface of a plug case or outlet Case that is charged with static electricity, the dust collecting on the surface can cause sparks at the electrical connecting point between the plug and outlet, resulting in fire.

### SUMMARY OF THE INVENTION

In view of the foregoing, it is an object of the present invention to provide a power-cord connection set that has a simple construction, that is capable of achieving a reliable connection between power cables in the outlet and power cables in the electric or electronic equipment, and that is capable of sealing the electrical conducting area from external matter. It is another object of the present invention to provide a power-cord connection set that has a ground wire having a conducting member for the ground wire at the area of electrical connection between the plug and outlet, and that is capable of maintaining a seal around this area.

These objects and others will be attained by a power-cord connection set comprising (1) a plug having a plug case and a pair of plug terminals mounted in the plug case; (2) an outlet provided in the plug case positioned around the plug terminals; and (4) an annular joining depression having a tapered cross-section positioned around the insertion holes of the terminal receptors and formed to correspond to the annular joining protrusion, such that the juncture formed by the joining protrusion and joining depression forms a seal around the electrical conducting portions of the plug terminals and terminal receptors.

According to another variation of the present invention, a power-cord connection set having a ground function comprises (1) an annular joining protrusion that has a tapered cross-section and that is positioned around the plug terminals in the plug case; (2) an annular ground connector protruding from the end of the annular joining protrusion; (3) an annular joining depression that has a tapered cross-section and that is formed on the outlet Case and positioned around the insertion openings of the built-in terminal receptors so as to correspond to the annular joining protrusions; and (4) a ground connector that is built into the base of the annular joining depression and that has a receiving hole corresponding to the ground connector of the plug.

A variation of the present invention could be to detachably mount a hollow plug adapter on the plug case. The plug adapter has a space for inserting the plug case and an annular joining protrusion that has a tapered cross-section and that is formed around the plug terminals when the plug case is inserted to a prescribed position. An annular joining depression that has a tapered cross-section is formed on the outlet Case and is positioned around the insertion openings of the built-in terminal receptors so as to correspond to the annular joining protrusions. A connector is built into the base of the annular joining depression, and said connector the plug case and an annular joining protrusion that has a tapered cross-section and that is formed around the plug terminals when the plug case is inserted to a prescribed position. An annular joining depression that has a tapered cross-section is formed on the outlet Case and is positioned around the insertion openings of the built-in terminal receptors so as to correspond to the annular joining protrusions. A connector is built into the base of the annular joining depression, and said connector has a receiving hole corresponding to the connector of the plug.

In this case, elastic hooks should be formed on the plug case or plug adapter for applying an outward urging force, and hook-engaging units corresponding to the ends of the hooks should be formed on the opening end of the annular joining depression. Further, it is desirable to provide a retaining unit on the back of the case so as to maintain the electric cords (and ground lead wires) for the plug and outlet in an insulated state.

### BRIEF DESCRIPTION OF THE DRAWINGS

In the drawings:

FIG. 1 is a perspective view showing the outlet and plug of the power-cord connection set according to a first embodiment in an unconnected state;

FIG. 2 is a is a cross-sectional plan view showing the outlet and plug of the power-cord connection set of FIG. 1 in a connected state;

FIG. 3 is a cross-sectional plan view showing the plug adapter of FIG. 1;

FIG. 4 is a cross-sectional plan view showing the plug adapter according to a variation of the embodiment;

FIG. 5 is a perspective view showing the outlet and plug of the power-cord connection set according to a second embodiment;

FIG. 6 is a cross-sectional plan view showing the power-cord connection set of FIG. 5 in a connected state;

FIG. 7 is a side cross-sectional view showing the power-cord connection set of FIG. 5; and

FIG. 8 is a perspective view showing the outlet Case for the power-cord connection set of FIG. 5.

### DESCRIPTION OF THE PREFERRED EMBODIMENTS

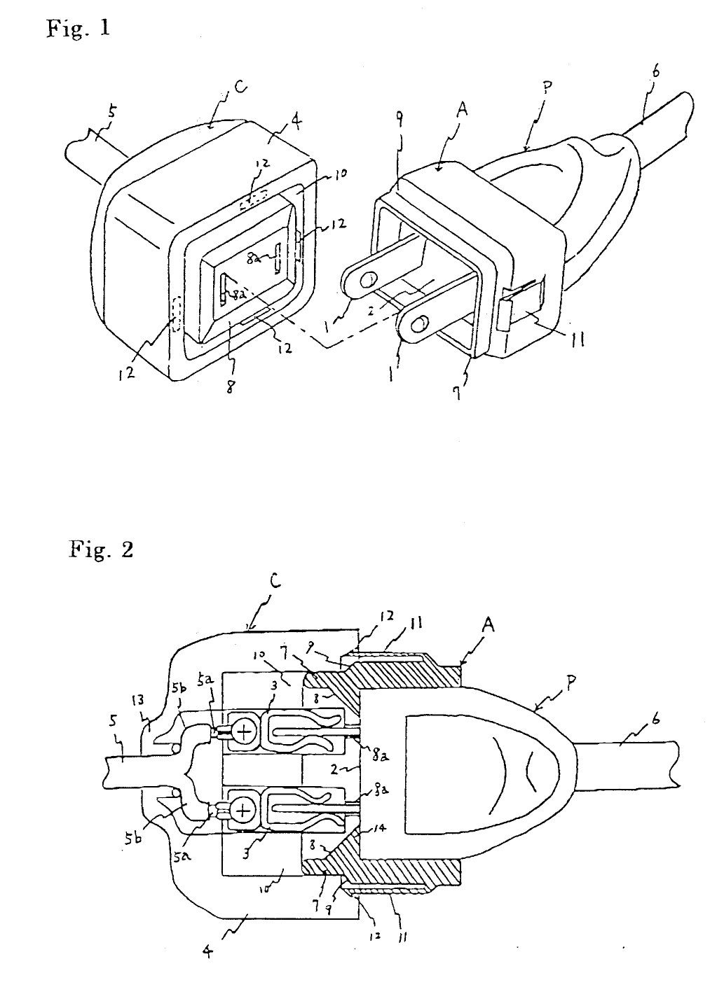

A power-cord connection set according to preferred embodiments of the present invention will be described while referring to the accompanying drawings. A power-cord connection set according to a first embodiment is shown in FIGS. 1 and 2.

The power-cord connection set of the first embodiment includes a plug P and an outlet C appropriately connecting lead wires that are provided in an electric cord 5 for the outlet and an electric cord 6 for the plug. The plug P includes a pair of plug terminals 1 and a plug case 2 in which the power plug terminals 1 are mounted. The plug case 2 is composed of an insulating material, such as a hard synthetic resin. A plug adapter A is detachably mounted on the plug P. The outlet C includes a pair of terminal receptors 3 that correspond to the pair of plug terminals 1 and an outlet Case 4 in which the terminal receptors 3 are mounted.

In the present embodiment, the electric cord 5 and electric cord 6 are provided with lead wires 5a and insulating sheathes 5b formed around the lead wires 5a.

As shown by FIG. 3, the plug adapter A, which is mounted on the plug case 2, is hollow and preferably formed of a synthetic resin having slight elasticity. The plug adapter A includes a space in which the plug case 2 is inserted. An annular joining protrusion 9 having a tapered cross-section is formed at the end of the plug adapter A around the plug terminals 1. An annular connector 7 protrudes from the end of the joining protrusion 9. When necessary, an engaging step 14 is formed on the inner surface of the plug adapter A so as to prevent the plug case 2 from being inserted past a prescribed position.

An annular joining depression 10 having a tapered cross-section is formed in the outlet Case 4 around the insertion holes of the terminal receptors 3 and corresponding to the joining protrusion 9. The base end of the joining depression 10 is provided with a connector 8 corresponding to the connector 7 on the plug end. The connector 8 is formed with receiving holes 8a corresponding to the plug terminals 1.

Hooks 11 formed of an elastic material that provides an outward urging force are provided on the left and right side (or on the top and bottom) of the plug adapter A. Hook-engaging units 12 are formed near the opening lip of the joining depression 10, and these hook-engaging units correspond to the ends of the hooks 11. Although FIGS. 1 and 2 show the hook-engaging units 12 spanning the inner and outer edges of the opening in the joining depression 10, the hook-engaging units 12 can also be positioned only in the tapered surface of the inner edge. In this case, it is possible to provide the inner opening of the joining depression 10 with a four-sided tapered surface for accommodating the hooks 11, which are positioned on the left and right or top and bottom of the plug case 2.

The plug P and outlet C maintain the electric cord 5 and electric cord 6 on the rear of the case such that the same are in an insulated state.

With this construction, the joining protrusion 9 serves as a guide to the joining depression 10 when the plug terminals 1 are inserted into the terminal receptors 3 so as to connect the plug P to the outlet C. Accordingly, the plug terminals are guided into the receiving holes 8a to the correct position, thereby achieving a reliable connection between the power terminals and with the connector 8.

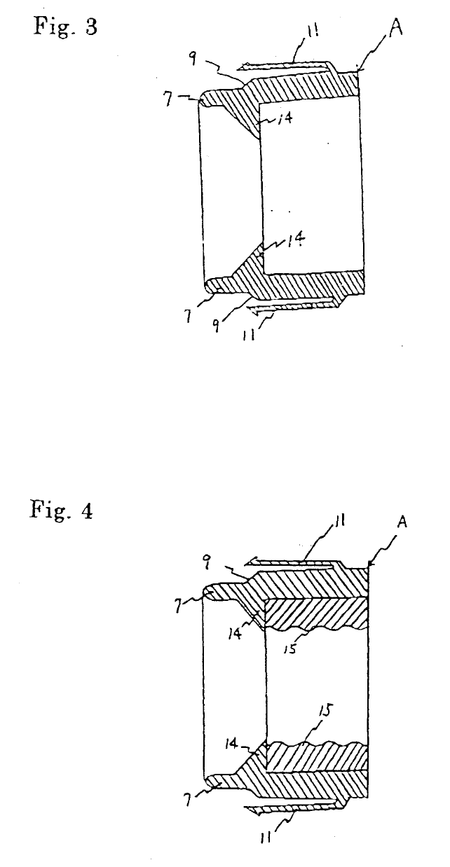

As shown in FIG. 4, a soft layer 15 that is composed of a foam resin such as urethane and that has an appropriate thickness can be provided on the inner surface of the plug adapter A. With this construction, the soft layer 15 is compressed when the plug case 2 is inserted into the plug adapter A, thereby creating a mechanical retaining force with the plug adapter A to accommodate the plug case 2 in a stable state. The outlet C shown in FIGS. 1 through 4 is shaped to conform to the plug P. It is also possible to provide either a tap outlet that is capable of connecting with a plurality of plugs P, or an embedded outlet that is embedded in a wall or in a box outlet that protrudes from a wall, in order to connect one or a plurality of plugs P.

In the power-cord connection set of the present embodiment, a plug adapter is detachably mounted on the plug case. The plug adapter is formed with a tapered annular joining protrusion around the plug terminals and an annular plug connector protruding from the end thereof. A tapered annular joining depression is formed in the outlet Case around the insertion holes for the built-in terminal receptors, and said depression corresponds to the aforementioned annular joining protrusion. An outlet Connector is provided on the base end of the annular joining protrusion, and said outlet Connector has a receiving hole corresponding to the plug terminal.

Accordingly, the present invention enables an easy configuration and reliable connection between the electrical connections of the outlet and plug and the outlet and plug themselves simply by mounting the plug adapter on a normal plug. Further, a seal is formed by fitting the tapered annular joining portions together, thereby effectively preventing dust or the like from entering the terminal receptors for the plug terminals.

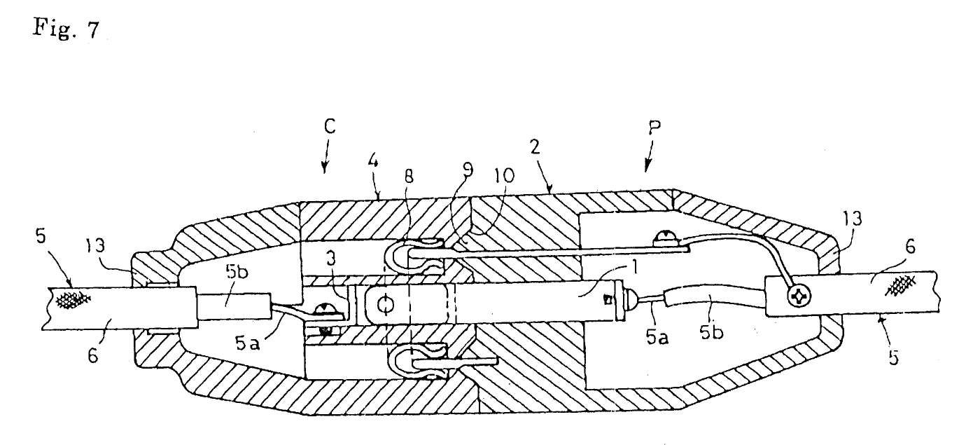

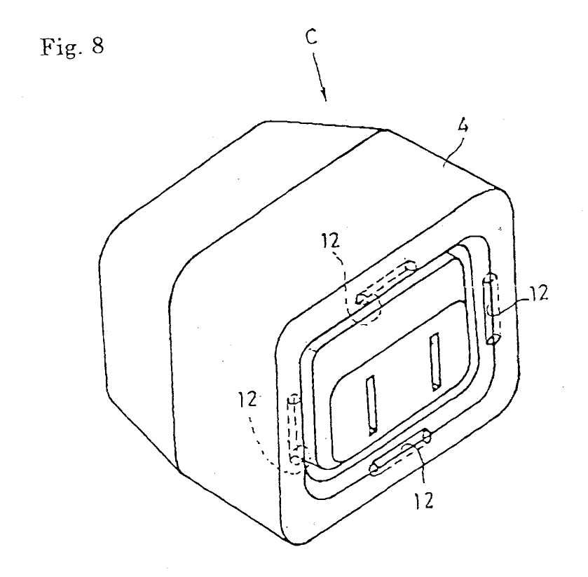

Next, a power-cord connection set according to a second embodiment of the present invention will be described with reference to FIGS. 5 through 8.

A cord connection set having a grounding function according to the second embodiment includes a plug P and an outlet C for appropriately connecting lead wires provided in an electric cord 5 for the outlet and an electric cord 5 for the plug. The plug P includes a pair of plug terminals 1, a plug case 2 in which the power plug terminals 1 are mounted, and a ground connector 7. The plug case 2 is composed of an insulating material such as a hard synthetic resin. The outlet C includes a pair of terminal receptors 3 corresponding to the pair of plug terminals 1, an outlet Case 4 in which the terminal receptors 3 are mounted, and a ground connector 8.

In the present embodiment, the electric cords 5 are provided with lead wires Sa, insulating sheathes 5b that are formed around the lead wires Sa, and ground lead wires 6 including a plurality of thin metal wires that cover the outside of the insulating sheathes 5b in a braided form. The ground lead wires 6 are connected to the ground connector 7 in the plug P and to the ground connector 8 in the outlet C.

An annular joining protrusion 9 having a tapered cross-section is formed on the plug case 2 around the plug terminals 1. The ground connector 7 protrudes from the end of the joining protrusion 9. An annular joining depression 10 that has a tapered cross-section and that corresponds to the joining protrusion 9 is formed on the outlet Case 4 around the terminal receptors 3. The ground connector 8 is provided on the base of the joining depression 10, and said ground connector has receiving holes 8a corresponding to the connector 7.

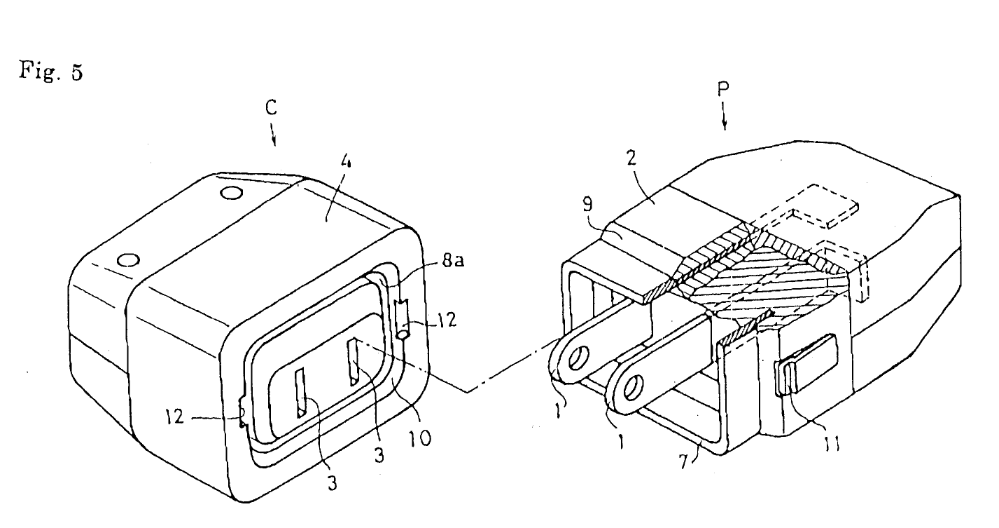

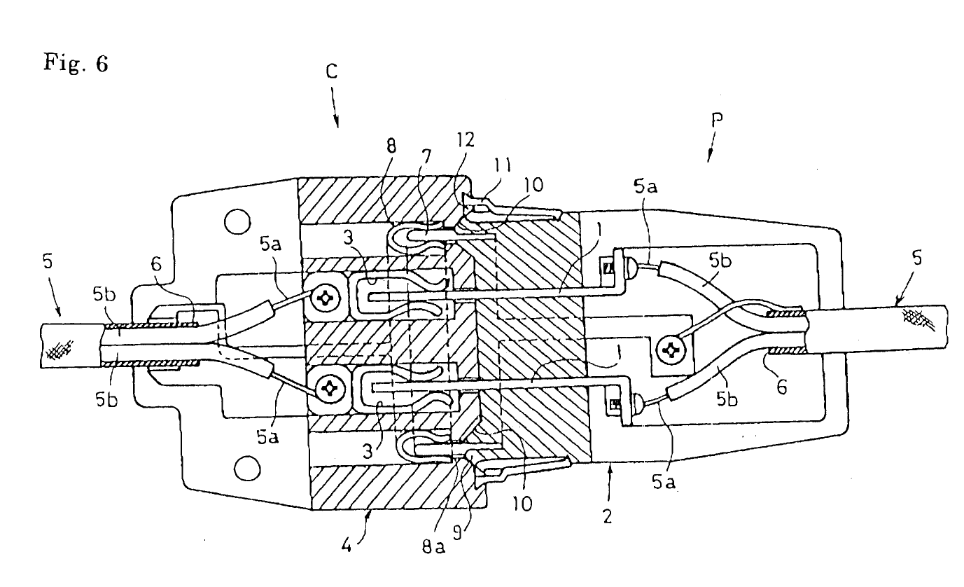

Hooks 11, formed of an elastic material, that provide an outward urging force are provided on the left and right side (or on the top and bottom) of the plug case 2. Hook-engaging units 12 are formed near the opening lip of the joining depression 10 and correspond to the ends of the hooks 11. Although FIGS. 5 and 6 show the hook-engaging units 12 straddling the inner and outer edge of the opening in the joining depression 10, the hook-engaging units 12 can also be positioned only in the tapered surface of the inner edge. In this case, it is possible to provide the inner opening of the joining depression 10 with a four-sided tapered surface for accommodating the hooks 11 positioned on the left and right or top and bottom of the plug case 2, as shown in FIG. 8.

In the present embodiment, the plug P and outlet C are provided with a retaining unit 13 that is well-known in the art for gripping and maintaining the electric cord 5 and ground lead wires 6 from above and below at the back of the plug case and outlet Case in order to maintain the same in an insulated state.

With this construction, the joining protrusion 9 serves as a guide to the joining depression 10 when inserting the plug terminals 1 into the terminal receptors 3 so as to connect the plug P to the outlet C. Accordingly, the connector 7 is guided into the receiving holes 8a to the correct position, thereby achieving a reliable connection between power terminals and with the connector 8.

The outlet C shown in FIGS. 5 through 8 is shaped to conform to the plug P. It is also possible to provide a tap outlet Capable of connecting with a plurality of plugs P, or an embedded outlet that is embedded in a wall or a box outlet that protrudes from a wall so as connect one or a plurality of plugs P. There are various other possible variations, such as providing a plug unit having the same shape as the plug P on one side of the tap outlet and forming a plurality of interconnectable tap outlets so as to create a series of tap outlets.

What is claimed is:

1. (amended) A power-cord connection set comprising:
a plug having a plug case and a pair of plug terminals mounted in the plug case;
a hollow plug adapter that is detachably mounted on the plug case and that comprises both a space for inserting the plug case and an annular joining protrusion that has a tapered cross-section that is positioned around the plug terminals when the plug case is inserted to a prescribed position;
an annular joining depression that has a tapered cross-section and that is positioned around the insertion holes of the terminal receptors in the outlet Case and formed so as to correspond to the annular joining protrusion; and
a connector that is built into the base end of the joining depression and that has receiving holes corresponding to the connection leads on the plug end.

2. (amended) A power-cord connection set as recited in claim 2, further comprising elastic hooks formed on the plug adapter for applying an outward urging force and hook-engaging units that are formed on the opening end of the annular joining depression and that correspond to the ends of the hooks.

3. (amended) A power-cord connection set as recited in claim 2, further comprising retaining units formed on the plug and outlet for holding the power cords for the outlet and the electric or electronic apparatus on the outlet Case and plug case so as to maintain the power cords in an insulated state.

4. (amended) A power-cord connection set as recited in claim 2, further comprising a soft layer of material formed on the inner surface of the plug adapter that contacts the plug case so as to maintain the joining strength between the plug adapter and the plug case.

5. (amended) A power-cord connection set comprising:
a plug having a plug case and a pair of plug terminals mounted in the plug case;
an annular joining protrusion that has a tapered cross-section and that is positioned around the plug terminals in the plug case;
a plug adapter that is detachably mounted on the end of the joining protrusion;
an annular plug connector that protrudes from the end of the plug adapter;
an annular joining depression that has a tapered cross-section and that is formed on the outlet Case and positioned around the insertion openings of the built-in terminal receptors so as to correspond to the annular joining protrusions; and
an outlet Connector that is built into the base of the annular joining depression and that has a receiving hole corresponding to the plug connector.

6. (amended) A power-cord connection set as recited in claim 6, further comprising elastic hooks that are formed on the plug case so as to apply an outward urging force, and hook-engaging units that are formed on the opening end of the annular joining depression and that correspond to the ends of the hooks.

7. (amended) A power-cord connection set as recited in claim 6, further comprising retaining units that are formed on the plug and outlet so as to hold the power cords and ground leads for the outlet and the electric or electronic apparatus on the backs of the outlet Case and plug case so as to maintain the power cords in an insulated state.

8. (deleted)
